(19) United States
(12) Patent Application Publication
(10) Pub. No.: US 2018/0209201 A1
(43) Pub. Date: Jul. 26, 2018

(54) DRIVE FOR A ROTATABLE WING

(71) Applicant: Gotthard 3 Mechatronic Solutions AG, Muri AG (CH)

(72) Inventor: Stefan SCHIMON, Hämikon (CH)

(21) Appl. No.: 15/744,889

(22) PCT Filed: Jul. 20, 2016
(86) PCT No.: PCT/EP2016/067247

§ 371 Date: Jan. 15, 2018

(30) Foreign Application Priority Data
Jul. 23, 2015 (CH) 1076/15

(51) Int. Cl. E05F 15/614; E05F 1/10

(52) U.S. Cl. CPC E05F 15/614; E05F 1/105; E05Y 2201/638; E05Y 2201/474; E05Y 2201/412

(57) ABSTRACT

A drive for a rotatable wing, the drive including an electric motor, a transmission, an output shaft, which is coupled to the electric motor by means of the transmission and can be coupled to the wing in order to move the wing between a closed position and an open position by means of the electric motor, and a force device for applying a force to the output shaft. The drive can have a compact design in that the force on the output shaft produces a torque that has a threshold value which must be overcome in the currentless state of the electric motor in order to move the wing from the closed position to the open position and that disappears in the open position of the wing, and/or in that the force device has a spring arranged transversely to the axis of the drive shaft of the electric motor and transversely to the axis of the output shaft.

The invention relates to a drive for a rotatable wing comprising an electric motor that is coupled via a gear to an output shaft which is coupleable to the wing.

Drives of this type are used, for example, to automatically move a wing in the form of a door or a window between a closed position and an open position; see, for example, DE 010 2006 002 751 A1, WO 2013/160087 A2, DE 10 2007 002 650 A1, and DE 103 36 075 B4. The drives described in these documents have an energy store that causes a wing that is in the open position to be moved into the closed position in the event of a power failure. The drive has quite a large volume due to providing this type of energy store.

It is an aim of the present invention to provide a more compact drive for a rotatable wing.

The invention achieves this aim with the subject matter of patent claim 1 or 2. The dependent claims define preferred embodiments of the drive.

In the drive according to claim 1, a force device is provided by means of which a closed wing is held in the closed position in the currentless state of the electric motor. The force device thus takes on a holding-closed function. In contrast, in the open position of the wing the force device has no effect, unlike the known drives, in which an open wing is moved into the closed position in the currentless state. The drive according to claim 1 may thus have a more compact design.

A compact design of the drive is also achievable in that according to claim 2 the force device has a spring that is situated transversely to the axis of the drive shaft of the electric motor and transversely to the axis of the output shaft.

Additional specific design features and their advantages are apparent from the following description and drawings of exemplary embodiments, in which

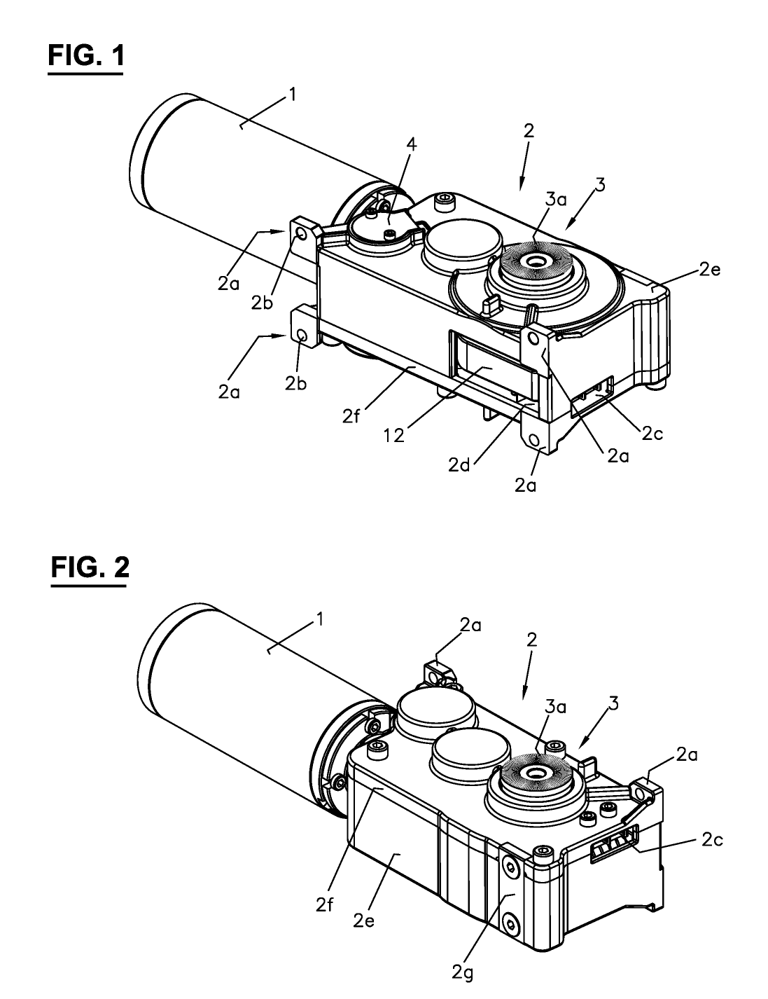

FIG. 1 shows a first exemplary embodiment of a drive in a perspective view,

FIG. 2 shows the drive from FIG. 1 in a view that is rotated by 180 degrees,

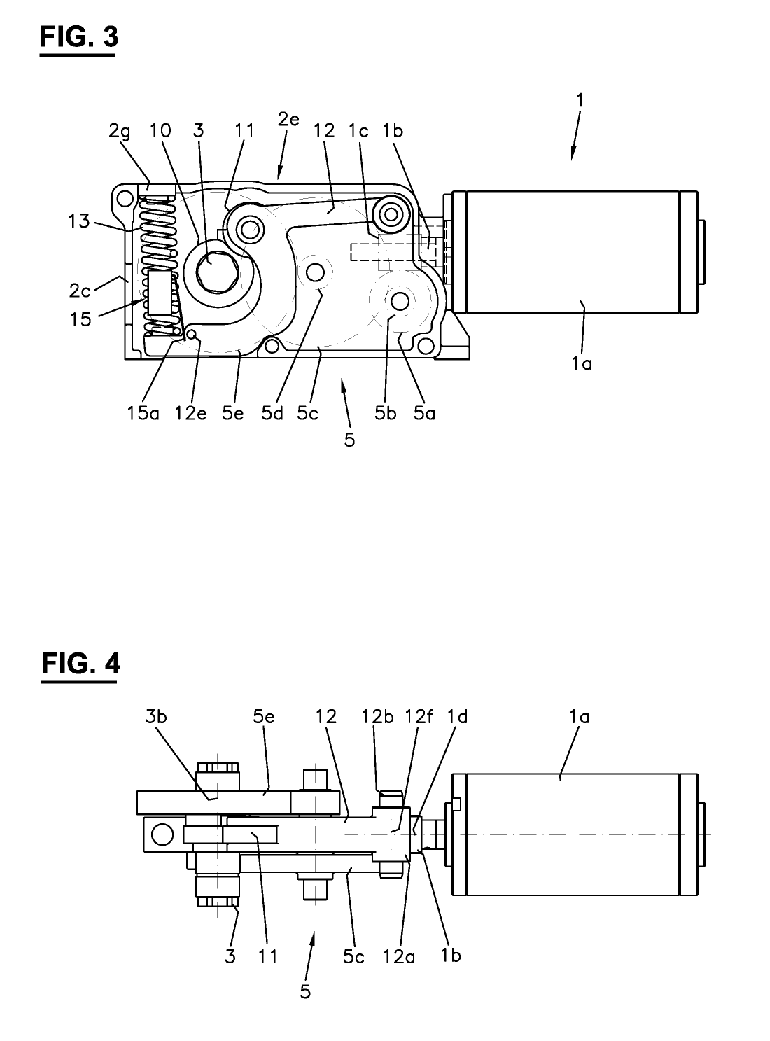

FIG. 3 shows the drive from FIG. 2 without a housing cover, in a top view,

FIG. 4 shows the drive from FIG. 1 without a housing, in a side view,

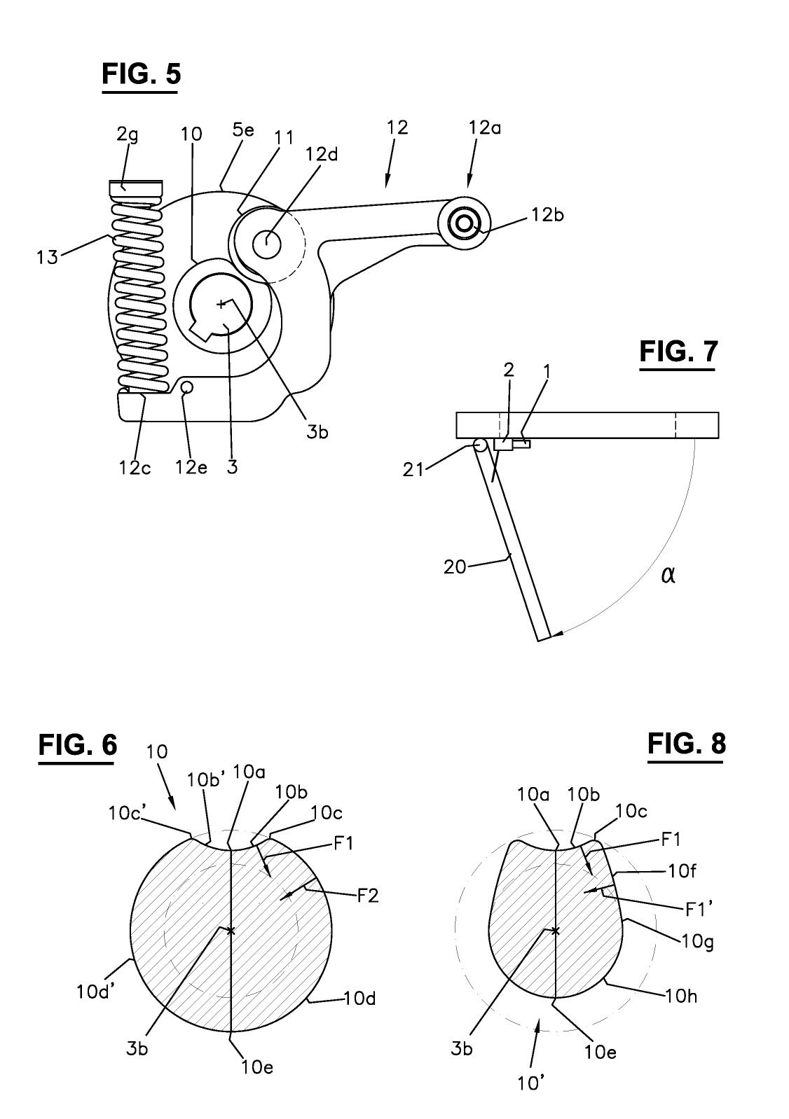

FIG. 5 shows a top view of the force device of the drive from FIG. 1,

FIG. 6 shows an example of a cam disk for the force device from FIG. 5,

FIG. 7 shows a schematic top view of a rotatable wing with a drive according to FIG. 1 coupled thereto,

FIG. 8 shows another example of a cam disk for the force device from FIG. 5,

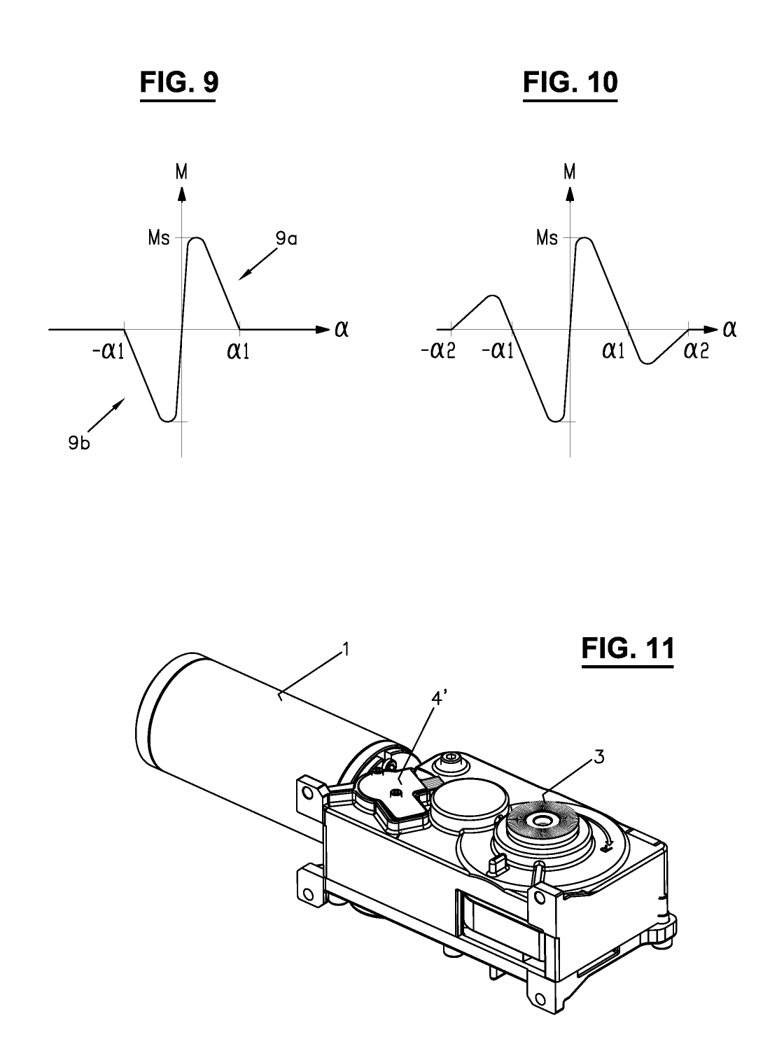

FIG. 9 shows the torque that is generatable by the force device according to FIG. 5, which includes the cam disk according to FIG. 6,

FIG. 10 shows the torque that is generatable by the force device according to FIG. 5, which includes the cam disk according to FIG. 8, and

FIG. 11 shows another exemplary embodiment of a drive in a perspective view.

The drive shown in FIGS. 1 and 2 has an electric motor 1 that is situated on the side of a housing 2 in which, among other things, the moving parts are accommodated, and from which the output shaft 3 protrudes.

The housing 2 includes a first housing part 2e made up of a housing base and a housing wall which protrudes therefrom and which is preferably molded on in one piece, and a second housing part 2f which is used as a housing cover and which is fastened to the first housing part 2e by screwing, for example. The housing 2 is provided with fastening means 2a in order to fasten the drive indirectly by means of a plate, for example, or directly to a casing, a frame, a lintel, or the like. Extensions 2a which are situated on one side of the housing 2 and which in each case have a through opening 2b for a screw are used here as fastening means. The respective extension 2a is preferably designed in one piece with the housing part 2e or 2f. The housing 2 has a window 2c that is used as access for allowing connection of a cable for a switch 15 (see FIG. 3). In the present exemplary embodiment, the housing 2 is provided with a further window 2d in order to make room for a movable component, in the present case a pivot lever 12, thus allowing a preferably compact design of the drive. Depending on the design of the housing 2, the window 2d may also be omitted.

The output shaft 3 is coupleable to the wing to be moved. This coupling takes place indirectly, for example by means of a linkage mechanism (for example, a slide linkage, toggle lever linkage, or scissor linkage, etc.), or also directly. The wing may be, for example, a door, in particular a door for a room or a French window, a window, or some other flat, rotatably supported part. The wing is movable back and forth between a closed position in which a passage is closed by means of the wing, and an open position in which the wing is maximally rotated. The wing may have a design that opens to the left, opens to the right, or swings. In the latter case, the open position is understood to mean a position in which the swinging wing is maximally rotated in the clockwise or the counterclockwise direction.

In the present exemplary embodiment, the drive is designed in such a way that the output shaft 3 protrudes from both sides of the housing 2, and each end of the output shaft 3 is thus coupleable to a wing. In this way, a wing that opens to the left or to the right may be selectively moved using one and the same drive. For example, the drive is mounted in the orientation as shown in FIG. 1, or is then rotated by 180 degrees, as shown in FIG. 2. For mounting, the orientation of the drive is selected in such a way that the end of the output shaft 3 that has the desired rotational direction during operation is the end that is coupleable to the wing. The end of the output shaft 3 is provided with a polygonal edge with which a coupling part 3a engages. The coupling part in the present case has a ring with flat toothing that allows fine adjustment of the coupling to the wing, in order to make it easier to bring the starting and end positions of the output shaft into precise alignment with the desired starting and end positions of the wing.

An angle sensor 4 that is used for detecting the position of the coupled wing is mounted on the housing 2. The angle sensor 4 is designed as a Hall sensor, for example, and includes a magnet that is coupled to the rotating part, and whose field is detected by a stationary element. However, sensors that do not operate contactlessly, for example sensors with a rotatable slider that contacts a resistive track, are also usable as angle sensors 4.

As shown in FIG. 3, the electric motor 1 has a motor housing 1a from which the drive shaft 1b protrudes. The drive shaft terminates in the housing 2, and is provided with a worm 1c that is in operative connection with the output shaft 3 via a gear 5.

The gear 5, of which only the effective radii of the individual gear parts 5a-5e are indicated by dashed lines in FIG. 3, is designed as a multistage reduction gear. In the present example, the gear 5 has the following components:
a rotatably supported worm wheel 5a that is engaged with the worm 1c,
a pinion 5b that is situated on the same rotational axis as the worm wheel 5a and is engaged with a gearwheel 5c,
a further pinion 5d that is situated on the same rotational axis as the gearwheel 5c and is engaged with a gearwheel 5e.

The gearwheel 5e is rotatably fixedly connected to the output shaft 3. The housing 2 has suitable bearings (not illustrated in FIG. 3) for rotatably supporting the gear element 5a and 5b as well as the gear element 5c and 5d.

Of course, depending on the design, a different configuration of the gear 5 is possible for converting the movement of the drive shaft 1b into a desired movement of the output shaft 3.

The drive is further provided with a force device 10-13 that acts on the output shaft 3. The force device, which is also illustrated in FIG. 5, in the present case includes the following components:
a cam disk 10 that is rotatably fixedly connected to the output shaft 3, and through which the output shaft passes,
a pressure roller 11 that is rollable along the end-face side of the cam disk 10,
a pivot lever 12 on which the pressure roller 11 is rotatably accommodated, and
a spring 13 that cooperates with the pivot lever 12.

On one end 12a the pivot lever 12 has a bearing location about which the pivot lever is pivotable, and which in the present case is situated adjoining the drive shaft 1b. The axis 12f about which the pivot lever 12 is pivotable is in parallel to the axis 3b of the output shaft 3 (see FIG. 4). For forming the bearing location, the end 12a includes a bushing that is able to slide about an axle 12b accommodated in the bushing. The end 12a with the bushing is designed here in one piece with the pivot lever 12. The axle 12b is fastened to both sides of the housing 2 by means of screws, for example. Of course, other designs for pivotably supporting the pivot lever 12 are conceivable.

The other end 12c of the pivot lever 12 is used as a stop for the spring 13. A bearing location 12d for rotatably supporting the pressure roller 11 on the pivot lever 12 is situated between the two ends 12a, 12c. The pressure roller 11 has, on the end-face side, a circular cylindrical surface, which contacts the cam disk 10.

The pivot lever 12 has a course with an S shape in the present case, and passes through the space in which the gear 5 is situated. The pivot lever 12 is situated in such a way that, in the top view according to FIG. 3 and thus viewed in the direction of the axis 3b of the output shaft 3, the drive shaft 1b is situated on one side of the pivot lever 12, and the output shaft 3 is situated on the other side of the pivot lever 12. In the side view according to FIG. 4, and thus viewed transversely to the direction of the axis 3b of the output shaft 3, the pivot lever 12 is situated between the gearwheels 5c and 5e.

In the present exemplary embodiment, the pivot lever 12 includes an actuating element 12e for actuating a switch 15 as a function of the position of the pivot lever 12. The switch 15 is used as an information transmitter that delivers a signal when the wing is in an end position (closed position or open position). The switch 15 in the present case is situated at the spring 13 and is fastened to the housing 2. The actuating element 12e is designed, for example, in the form of an extension that acts on a lever 15a when the pivot lever 12 pivots, thus activating the switch 15 (see FIG. 3).

As explained above, an angle sensor 4 is provided for detecting the position of the wing. In the present exemplary embodiment, the angle sensor 4 is integrated into the worm wheel 5a. However, it is also possible to couple the angle sensor 4 to some other gear element in order to detect its angular position. Since the gear ratios of the gear 5 are known, the angular position of the output shaft 3 may be deduced from the angular position of the gear element. Depending on the design of the angle sensor 4, the exact position of a wing that is coupled to the drive may be unknown. By use of the switch 15, at least one additional reference value is available for calibrating the values of the angle sensor 4 to allow detection of the exact position of the wing, for example in the closed position. The switch 15 may also be omitted when using an absolute encoder, for example, as the angle sensor 4.

The spring 13 is situated transversely to the axis 1d of the drive shaft 1b of the electric motor 1 and transversely to the axis 3b of the output shaft 3, which allows a particularly compact design of the drive. The output shaft 3 is situated between the spring 13 and the drive shaft 1b of the electric motor 1, viewed in the direction of the axis 3b of the output shaft 3. The spring 13, as illustrated here in the figures, is designed as a compression spring, for example. Other types of springs, such as disk springs, are also usable. The spring 13 is situated between the end 12c of the pivot lever 12 and a stop plate 2g that is mounted in a window of the housing 2, for example by screwing (also see FIG. 2). This design simplifies assembly of the drive, in that the spring 13 is inserted into the housing 2 through the window and then tensioned by attaching the stop plate 2g. Alternatively, it is conceivable to provide a stop having a one-piece design with the housing part 2e, and during assembly to insert the spring 13 into the housing space from the side which is the top side according to FIG. 4.

The components 10-12 form a cam gear that is configured for converting the force generated by the spring 13 into a desired torque on the output shaft 3.

The spring 13 preferably has a linear characteristic curve in the working range, so that the force generated by the spring 13 is proportional to its spring excursion.

The cam disk 10 is rotatable about the center of rotation defined by the axis 3b of the output shaft 3, and has a rolling surface on the end-face side with a specific profile, resulting in a nonuniform edge. FIG. 6 shows one possible example of this profile, which includes the following sections:
a concavely curved section 10b that extends from a first position 10a to a second position 10c,
a section 10d that extends from the second position 10c to a third position 10e, in a circle about the axis 3b as the center,
a section 10d′ that extends from the third position 10e to a fourth position 10c′, in a circle about the axis 3b as the center, and
a concavely curved section 10b′ that extends from the fourth position 10c′ to the first position 10a.

The profile in the present case has a mirror-symmetrical design about the center axis, which passes through the positions 10a and 10e. The cam gear 10-12 accordingly has the same action on a wing which opens to the left or to the right and which is coupled via one end or the other of the output shaft 3. It is also conceivable to provide the drive at the intended rotational direction of the wing, and thus, to configure only one side of the profile corresponding to the sections 10b and 10d or the sections 10b′ and 10d′, while the other side of the profile may have any shape.

By providing the cam disk 10 with an indentation that is defined by section 10b or 10b′, a holding-closed torque having a threshold value is exertable on the wing, while the circular section 10d or 10d′ generates no torque on the wing. This, in addition to use of the drive, is explained in greater detail below:

The drive is situated, for example, on the side of the wing on which the hinges are present. The hinges are situated on the left, for example, so that the wing opens to the left. The drive is mounted in the orientation according to FIG. 1, for example, so that the output shaft 3 is coupled to the wing with the end that is visible in FIG. 2. This arrangement by way of example is illustrated in FIG. 7, which schematically shows a wing 20 rotatably supported in hinges 21, and the components 1, 2 of the drive coupled thereto. α denotes the angle of the wing 20 between its closed position and its position at a given moment.

In the closed position of the wing 20 (α=0 degrees), the pressure roller 11 contacts a neutral position, which is situated in section 10b of the cam disk 10 and which may be close to position 10a. The location of the neutral position is adjustable by coupling the output shaft 3 to the wing in a certain angular position during installation of the drive. At this neutral position, the cam disk 10 is shaped such that the force exerted by the pressure roller 11 results in no, or reduced, torque M on the output shaft 3. If an external force now acts that is caused by a draft, for example, and an external torque Mo thus acts on the wing 20, the wing begins to rotate. The pressure roller 11 then moves along section 10b of the cam disk 10, while at the same time the pivot lever 12 pivots and the spring 13 is compressed. The spring acts on the pressure roller 11, via the pivot lever 12, with a force F1 that is directed not toward the output shaft axis 3b, but to the side of this axis (see FIG. 6). The force F1 accordingly generates a nonvanishing torque M on the output shaft 3, which counteracts the external torque Mo and thus moves the wing 20 into the closed position or holds it there.

The force device 10-13 thus fulfills a holding-closed function by keeping the wing in the closed position without electrical power, in particular without operation of the electric motor 1, when external influences act on the wing. The force device 10-13 is thus usable, for example, as a replacement for a door catch, which likewise fulfills a holding-closed function.

The force device 10-13 is configured in such a way that the holding-closed function is active in a limited angular range of the wing. If the wing has reached an intermediate position with a sufficiently large angle, the pressure roller is no longer located at section 10b or 10b′, but, rather, at circular section 10d or 10d′. At that location the pressure roller 11 exerts a force on the cam disk 10 which is directed toward the output shaft axis 3b, and which thus generates no torque M (see, for example, the force vector F2 depicted in FIG. 6).

The diagram in FIG. 9 shows the torque M that is generatable by the force device 10-13 as a function of the angle α. In the present case, M is point-symmetrical about the zero point due to the symmetrical design of the cam disk 10. Depending on the opening direction of the coupled wing, either the right area 9a or the left area 9b of the characteristic curve of M applies. It is apparent that, for example in area 9a, i.e., in the area where α≥0, M has the following curve: The torque M rises sharply close to zero, and then reaches a threshold value Ms, vanishes at α1, and then remains at zero. α1 is typically selected to have an absolute value less than 30 degrees. An analogous curve results in area 9b, where α≤0.

The drive also has an opening and closing function in addition to the holding-closed function. For automatically opening a wing, the electric motor 1 is set into operation by a trigger signal generated by a sensor, for example a motion detector or the like. The rotation of the drive shaft 1b is transferred to the output shaft 3 via the gear 5, with the pressure roller 11 rolling along the cam disk 10. The electric motor 1 and the gear 5 are designed in such a way that the threshold value Ms is overcome and the wing is brought beyond the intermediate position and into the open position. The open position is at an angle α, for example, having an absolute magnitude greater than 80 degrees. A further trigger signal once again sets the electric motor 1 into operation in order to automatically close the wing. After the intermediate position of the wing is reached, the force device acts to assist in the closing motion, since the torque M generated by the force device 10-13 and the torque generated by the electric motor 1 and the gear 5 are now oriented in the same direction.

The drive in the present case is designed in such a way that in the event of a power failure the wing remains in position when it is between the intermediate position and the open position, i.e., |α|>α1, since at that position the holding-closed torque M vanishes and the electric motor 1 is not active.

In another embodiment of the drive, it may be provided that the force device may result in an opening movement. FIG. 8 shows an example of a cam disk 10′ designed for this purpose. The cam disk is illustrated here with a mirror-symmetrical profile, wherein, the same as for the cam disk 10 explained above, it is also possible to provide only one side of the profile, and for the other side to have any shape. Therefore, only one side of the profile is discussed below. The description analogously applies to the other side. As shown in FIG. 8, the profile includes the following sections:
a concavely curved section 10b that extends from the first position 10a to the second position 10c, and corresponds, for example, to section 10b of the cam disk 10,
a convexly curved section 10f that extends from the second position 10c to a transition location 10g, and
a section 10h that extends from the transition location 10g to the third position 10e, in a circle about the axis 3b as the center.

In contrast to the cam disk 10, in the profile of the cam disk 10′ the indentation 10b does not directly merge into a circular section, but instead has a transition area 10f therebetween that does not lie on a circle having the axis 3b as the center. The distance from the center of rotation 3b of the cam disk 10, viewed in the direction from position 10c to position 10g, decreases along the transition area 10f. When the pressure roller 11 is in the transition area 10f, it exerts a force F1′ on the cam disk 10′ that is directed not toward the output shaft axis 3b, but to the side of this axis. However, on the other side of the output shaft axis 3b this force passes by as force F1, which is generated in area 10b, so that the algebraic sign of the generated torque M is changed here (see the vector of the force F1′ in the example according to FIG. 8, which points past to the right of the output shaft axis 3b, while the vector for force F1 points past to the left of the output shaft axis 3b.)

The resulting curve of the torque M as a function of the angle α is apparent from the diagram in FIG. 10: In the area from 0 to ±α1, the torque M, analogously to the example in FIG. 9, has a threshold value Ms for allowing the wing to be held in the closed position in the currentless state. In contrast to the example in FIG. 9, at the first intermediate position ±α1 the torque M changes its algebraic sign and vanishes after reaching a threshold value at the second intermediate position ±α2. In the event of a power failure and/or when the electric motor 1 is inactive, a torque M which moves the wing toward the open position accordingly acts on a wing that is situated in the area between the first and the second intermediate position.

In addition to this movement specification for the wing, providing the transition area 10f has the advantage that the area 10h may be situated on a circle having a smaller radius, and therefore the cam disk 10′ is more compact than the cam disk 10 (see FIGS. 6 and 8).

Based on the preceding description, numerous modifications are available to those skilled in the art without departing from the scope of protection defined by the claims.

In the example according to FIG. 3, in addition to the angle sensor 4, a switch 15 that is situated at the spring 13 is provided for reference. The design and arrangement of the sensor system for detecting the position of a wing may also be different. FIG. 11 shows an example in which a sensor 4′ is situated at the worm wheel. The sensor 4′ may, for example, be made up of a combination of an angle sensor and a switch for reference, an absolute encoder, or some other sensor.

1. A drive for a rotatable wing comprising:
an electric motor,
a gear,
an output shaft which is coupled to the electric motor via the gear and is coupleable to the wing in order to move the wing back and forth between a closed position and an open position by means of the electric motor, and
a force device for applying a force to the output shaft, which force generates a torque on the output shaft, which torque has a threshold value which is to be overcome in the currentless state of the electric motor in order to move the wing from the closed position to the open position and which torque vanishes in the open position of the wing.

2. A drive for a rotatable wing comprising:
an electric motor,
a gear,
an output shaft which is coupled to the electric motor via the gear and is coupleable to the wing in order to move the wing back and forth between a closed position and an open position by means of the electric motor, and
a force device for applying a force to the output shaft, the force device having a spring situated transversely to the axis of the drive shaft of the electric motor and transversely to the axis of the output shaft.

3. The drive according to claim 1, wherein the wing is movable from the closed position via an intermediate position to the open position, and wherein the force device is configured for exerting a torque on the wing which vanishes or acts in the direction toward the open position when the wing is in the intermediate position.

4. The drive according to claim 1, wherein the force device includes a cam gear that couples a, or the, spring to the output shaft.

5. The drive according to claim 1, wherein the force device includes a cam disk having at least one of the following features a) through e):
a) the cam disk is rotatably fixedly connected to the output shaft,
b) the cam disk has a profile with a section that extends in a circle about the center of rotation of the cam disk,
c) the cam disk has a profile with an indentation that merges into a, or the, circular section,
d) the cam disk has a profile with an indentation that merges into a transition section that is adjoined by a, or the, circular section, wherein the distance from the profile to the center of rotation of the cam disk decreases along the transition section,
e) the cam disk has a mirror-symmetrical profile.

6. The drive according to claim 1, wherein the force device includes a pivot lever having at least one of the following features a) through f):
a) the pivot lever is situated in such a way that, viewed in the direction of the axis of the output shaft, the drive shaft of the electric motor is situated on one side of the pivot lever, and the output shaft is situated on the other side of the pivot lever,
b) the pivot lever is situated in such a way that, viewed transversely to the axis of the output shaft, it is situated between gear elements of the gear,
c) the pivot lever includes an actuating element for actuating a switch as a function of the position of the pivot lever,
d) the pivot lever is pivotably supported on one end, and with the other end acts on a, or the, spring of the force device,
e) the pivot axis of the pivot lever is arranged parallel to the output shaft,
f) a rotatable pressure roller that contacts a, or the, cam disk is situated on the pivot lever.

7. The drive according to claim 1, having an angle sensor by means of which the angular position of the axis of a gear element of the gear is detectable.

8. The drive according to claim 7, wherein the angle sensor is coupled to a worm wheel of the gear, and/or has a magnet.

9. The drive according to claim 1, wherein the force device includes a spring having at least one of the following features a) through e):
a) the spring has a linear characteristic curve in the working range,
b) the spring is designed as a compression spring or a disk spring,
c) the spring, viewed in the direction of the axis of the output shaft, is situated in such a way that the output shaft is situated between the spring and the drive shaft of the electric motor.

10. The drive according to claim 2, wherein the wing is movable from the closed position via an intermediate position to the open position, and wherein the force device is configured for exerting a torque on the wing which vanishes or acts in the direction toward the open position when the wing is in the intermediate position.

11. The drive according to claim 2, wherein the force device includes a cam gear that couples a, or the, spring to the output shaft.

12. The drive according to claim 2, wherein the force device includes a cam disk having at least one of the following features a) through e):
a) the cam disk is rotatably fixedly connected to the output shaft,
b) the cam disk has a profile with a section that extends in a circle about the center of rotation of the cam disk,
c) the cam disk has a profile with an indentation that merges into a, or the, circular section,
d) the cam disk has a profile with an indentation that merges into a transition section that is adjoined by a, or the, circular section, wherein the distance from the profile to the center of rotation of the cam disk decreases along the transition section,
e) the cam disk has a mirror-symmetrical profile.

13. The drive according to claim 2, wherein the force device includes a pivot lever having at least one of the following features a) through f):
a) the pivot lever is situated in such a way that, viewed in the direction of the axis of the output shaft, the drive shaft of the electric motor is situated on one side of the pivot lever, and the output shaft is situated on the other side of the pivot lever,
b) the pivot lever is situated in such a way that, viewed transversely to the axis of the output shaft, it is situated between gear elements of the gear,
c) the pivot lever includes an actuating element for actuating a switch as a function of the position of the pivot lever,
d) the pivot lever is pivotably supported on one end, and with the other end acts on a, or the, spring of the force device,
e) the pivot axis of the pivot lever is arranged parallel to the output shaft,
f) a rotatable pressure roller that contacts a, or the, cam disk is situated on the pivot lever.

14. The drive according to claim 2, having an angle sensor by means of which the angular position of the axis of a gear element of the gear is detectable.

15. The drive according to claim 14, wherein the angle sensor is coupled to a worm wheel of the gear, and/or has a magnet.

16. The drive according to claim 2, wherein the force device includes a spring having at least one of the following features a) through e):
a) the spring has a linear characteristic curve in the working range,
b) the spring is designed as a compression spring or a disk spring,
c) the spring, viewed in the direction of the axis of the output shaft, is situated in such a way that the output shaft is situated between the spring and the drive shaft of the electric motor.
